(19) United States
(12) Patent Application Publication
(10) Pub. No.: US 2011/0250420 A1
(43) Pub. Date: Oct. 13, 2011

(54) COMPOSITE STIFFENER MATERIALS

(76) Inventor: Harold Kalde, St. Louis, MO (US)

(21) Appl. No.: 12/905,261

(22) Filed: Oct. 15, 2010

Related U.S. Application Data
(60) Provisional application No. 61/251,921, filed on Oct. 15, 2009.

(51) Int. Cl. B32B 3/00; B32B 27/12; B29D 35/12; D04H 13/00

(52) U.S. Cl. 428/220; 442/327; 442/398; 264/103; 264/244

(57) ABSTRACT

The present invention relates to composite stiffener materials in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point, prepared by a method comprising the steps of: (a) entangling the fibers to form a fabric, (b) heating the fabric to a temperature sufficient to melt at least one thermoplastic material of a multi-component fiber without permanent structural impairment of other fiber components, and (c) reducing the thickness of the heated fabric to form a non-woven sheet of fabric. One feature of the invention is the elimination of saturating non woven material in the formation of the composite material. The invention is also directed to articles, such as footwear, luggage, holsters, and related accessories, comprising the composite stiffener materials, including box toe blanks and counter blanks used in conventional shoe molding and lasting procedures.

### CROSS-REFERENCE TO RELATED APPLICATIONS

This application claims priority under 35 U.S.C. §119(e) to U.S. Provisional Patent Application No. 61/251,921, filed Oct. 15, 2009, the disclosure of which is incorporated herein by reference. This disclosure also makes uses of certain materials and processes disclosed in co-pending application Serial Number PCT/US09/053,763, filed Aug. 13, 2009, the disclosure of which is incorporated herein by reference.

### FIELD OF THE INVENTION

The present invention relates to methods of making composite stiffener materials for use in the fabrication of articles such as footwear, luggage, holsters, and related accessories. The invention is also directed to composite stiffener materials suitable for use in the shoe industry, such as box toe blanks and counter blanks used in conventional shoe molding and lasting procedures. The invention is also directed to articles comprising composite stiffener materials.

### BACKGROUND OF THE INVENTION

Economic issues are a great concern to businesses which design and manufacture consumer articles requiring stiffener materials such as footwear, luggage, holsters, and related accessories. Cost is a key issue, particularly in the construction of box toes and counters used in the shoe manufacturing process. These objects are often prepared from inexpensive components, such as fibers impregnated with one or more incompletely-coalesced thermoplastic materials.

Shoe manufacturing generally requires the assembly of components in a distinct order. The first step typically involves the joining of a shoe upper and liner by sewing. A box toe blank and the shoe upper and liner are joined together next, with the box toe blank, pre-softened by a solvent or heat, inserted between the liner and upper. The joined parts are then applied to a form, called a last. The box toe blank is generally pliable through the lasting procedure. If a liquid solvent is used, softened thermoplastic particles in the box toe coalesce, so that the fiber-impregnated thermoplastic materials firmly adhere to the upper liner form a continuous film. When the shoe is removed from the last, the box toe blank and the upper and liner are integrated into a relatively rigid structure.

A major challenge associated with the assembly process, is the need for strong adhesion between the uppers and the liners. Methods requiring solvent handling, or the use of adhesive-soaked blanks, are messy and time consuming. Several hours may be required for a solvent to evaporate or for an adhesive to dry, greatly extending the length of the manufacturing process. The length of time needed to mold back parts and complete lasting operations also can be critical, since shoe stiffeners must be molded when they are pliable, which must be long enough to complete the lasting operation.

A variety of composite fabric materials have been disclosed. U.S. Pat. No. 3,778,250, for example, discloses a thermoplastic tissue stiffener material in sheet form carrying a thermoplastic impregnated with incompletely-coalesced particles. U.S. Pat. No. 5,382,400 discloses a method for making nonwoven multicomponent polymeric fabric made with continuous helically-crimped filaments using a melt spinning process. U.S. Pat. No. 6,391,380 discloses a process of making a fabric-based stiffener material having thermal adhesive properties on its top and bottom surfaces by contacting a non-woven fabric with a latex forming a resin and a finely-divided powder adhesive polymer to form a latex-saturated non-woven fabric. US 2004/0253894A1 discloses three-dimensionally patterned stabilized multi-layer materials suitable for use in disposable absorbent articles. The absorbent core includes at least a first three-dimensionally patterned stabilized absorbent layer and a second absorbent layer adjacent to the first layer. The second absorbent layer may contain a fluff fiber, an absorbent fiber, each fiber optionally treated with a non-fugitive densification agent, and mixtures thereof.

A variety of stiffeners have been used to manufacture shoes. U.S. Pat. No. 5,560,985, for example, discloses a material in the form of molding sheet having a sandwich structure produced by preparing a fiber reinforced thermoplastic resin layer reinforced with a woven fabric or knitted web and a fiber-reinforced thermoplastic resin layer reinforced with a random mat. U.S. Pat. No. 5,733,826 discloses an insole for shoes comprising a needle-punched formed fabric, having an adhesive-free, abrasion-resistant, and emboss-bonded formed base fabric laminated on the foot-facing side of base fabric by an adhesive compound, wherein the base fabric is 50-60% by weight of fibers having a co-polyester sheath component having a melting temperature in the range of 110-140° C., and a polyethylene terephthalate core component having a melting temperature in the range of 255-260° C. U.S. Pat. No. 4,602,442 discloses an flexible insole for a shoe comprising a plurality of alternating layers of plastic films and reinforcing fabric with openings therein, the film layers adhering to the reinforcing fabric through the openings to the adjacent layer of plastic film, with two outer layers of non-woven fiber fleece being adhered to the outer layers of the plastic films. High component costs and manufacturing delays and are associated with each of these materials and methods.

### BRIEF SUMMARY OF THE INVENTION

The present invention relates to a method of preparing a composite stiffener material in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point, comprising the steps of: (a) entangling the fibers to form a fabric, (b) heating the fabric to a temperature sufficient to melt at least one thermoplastic material of a multi-component fiber without permanent structural impairment of other fiber components, and (c) reducing the thickness of the heated fabric to form a non-woven sheet of fabric. The invention also relates to the composite stiffener material, and articles comprising the composite stiffener material, made by a method of the invention as disclosed herein.

The present invention also relates to a composite stiffener material in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point. The invention also relates to articles comprising a composite stiffener material as disclosed herein, preferably including an extruded plastic film of resilient nature when the stiffener material is used in shoe manufacturing.

### BRIEF DESCRIPTION OF THE DRAWINGS

The foregoing aspects, features, and advantages of the invention, as well as presently preferred embodiments thereof, will become more apparent from the drawings and the detailed description, set forth below. Reference numerals indicate corresponding parts throughout the several figures of the drawings.

FIG. 1 sets forth a flow chart of a preferred multi-step method of making a composite non-woven stiffener material comprising multi-component fibers 1 that are carded and cross-lapped 2, entangled 3, passed through a heat source to melt one thermoplastic component of the multi-component fibers 4, rolled and compressed into thinner sheets of material 5, and cooled 6 to produce a finished composite non-woven stiffener material 7.

FIG. 2 sets forth a progressive series of steps, some optional, for preparing laminated composite stiffener material, which can be cut and shaped into article parts (e.g., footwear components) which can be applied or assembled into articles (e.g., shoes). The finished composite stiffener material (CSM) 7 can optionally be split into two or more thinner sheets of material 8, and a resilient material (RM) can optionally be bonded to at least one side of the split or un-split CSM 9 to produce laminated CSM, exemplified in 10 as RM-CSM, RM-CSM-RM, and CSM-RM-CSM. An outer later of low melt fiber or an adhesive applied as a film or applied discontinuously can optionally be bonded to at least one side of the laminated CSM to enhance the adhesiveness of the laminated CSM 11. The finished, un-laminated CSM 7, laminated CSM 10, or adhesive (double)-laminated CSM 11, can then be cut and shaped into article parts 12, which are assembled into articles 13.

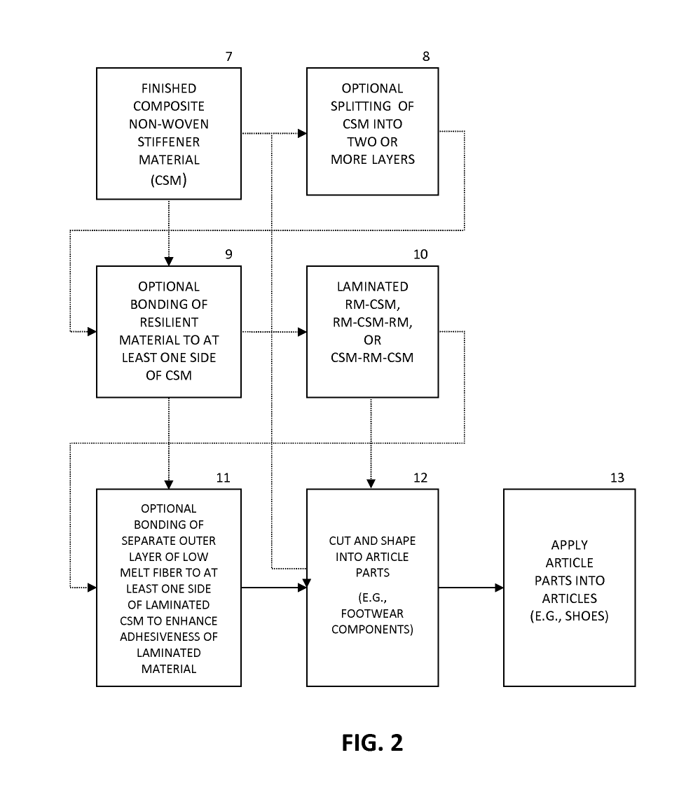

FIG. 3 sets forth a series of diagrams to illustrate the general steps involved in a preferred method of making a composite non-woven stiffener material or general features of the product obtained by the preferred process. Multi-component thermoplastic fibers are carded and cross-lapped, and passed through an entanglement device, preferably one that entangles the fibers by needling, which are then passed through a heater to melt one thermoplastic component of the entangled multi-component fibers.

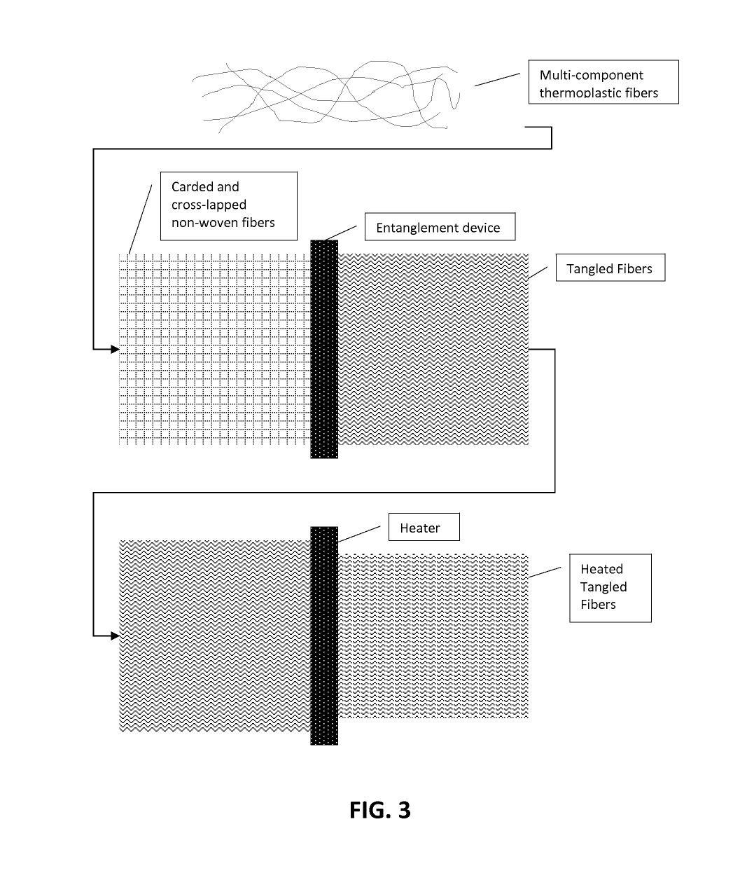

FIG. 4 illustrates the steps involved in compressing the heated tangled fibers using a roller to produce composite stiffener material. The finished material can optionally be split into two or more thinner sheets of material to produce finished composite stiffener material having the desired thickness.

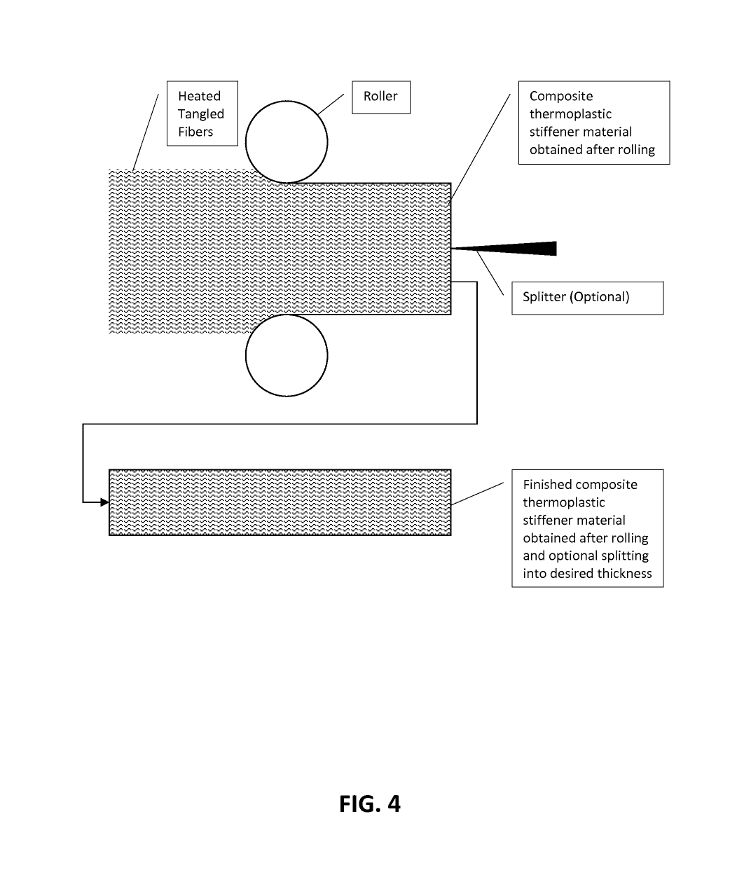

FIG. 5 sets forth a series of diagrams illustrating one method for the production of laminated and double-laminated CSM from un-laminated CSM. A resilient material (RM), such as a plastic film can be optionally be bonded to at least one side of the un-laminated CSM to form a laminated CSM, illustrated here as a sandwich, where the RM is sandwiched in the center of two sheets of un-laminated CSM. An outer layer of low-melt fiber, adhesive film, or discontinuously-applied adhesive can be bonded to at least one side the laminated CSM to produce a double-laminated CSM to enhance the adhesiveness of the laminated composite thermoplastic stiffener material.

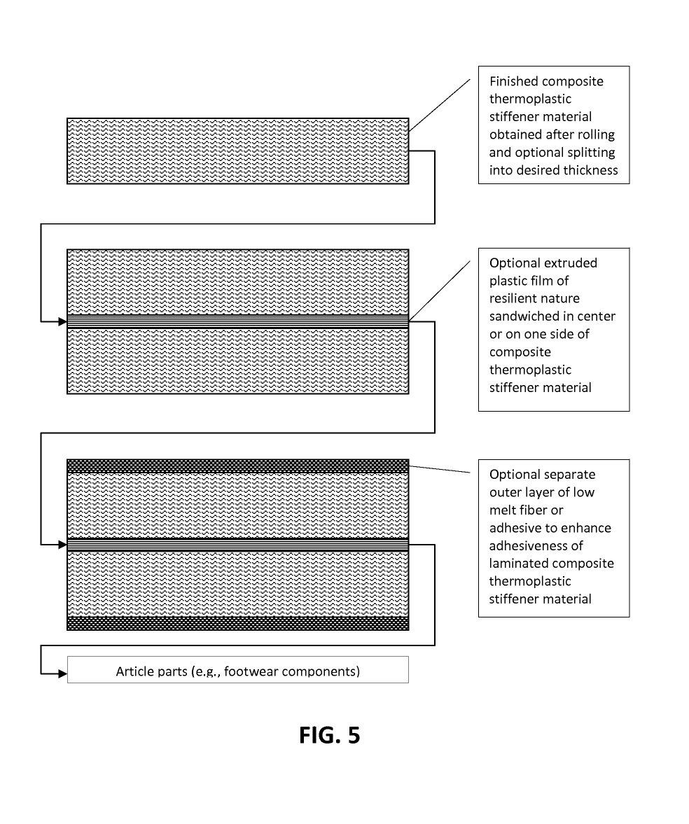

### DETAILED DESCRIPTION OF THE INVENTION

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The present invention relates to method of preparing a composite stiffener material in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point, comprising the steps of: (a) entangling the fibers to form a fabric; (b) heating the fabric to a temperature sufficient to melt at least one thermoplastic material of a multi-component fiber without permanent structural impairment of other fiber components; and (c) reducing the thickness of the heated fabric to form a non-woven sheet of fabric.

In a preferred aspect of the invention, the thermoplastic material in at least one component of the one or more multi-component fibers is a hot melt material or a polyester selected from the group consisting of polyglycolic acid (PGA), polylactic acid (PLA), polycaprolactone (PCL), polyethylene adipate (PEA), polyhydroxyalkanoate (PHA), polyethylene terephthalate (PET), polybutylene terephthalate (PBT), polytrimethylene terephthalate (PTT) polyethylene naphthalate (PEN) and vectran. In a more preferred aspect of the invention, the polyester is polyethylene terephthalate (PET). In a preferred aspect of the invention, the fibers comprise a blend of one or more multi-component fibers and one or more single-component fibers.

A variety of methods can be used to entangle the fibers to form a fabric. In a preferred aspect of the invention, the fibers are entangled by needle punching.

A variety of methods can be used to reduce the thickness of the fabric. In a preferred aspect of the invention, the thickness of the heated non-woven sheet fabric is reduced by passing the fabric through at least one set of rollers. In a preferred aspect of the invention, the non-woven sheet of fabric is split into two or more thinner non-woven sheets of fabric. The split and un-split fabrics may also be passed through one or more additional sets of rollers to provide a finished composite stiffener material having a uniform surface and a desired thickness. In a more preferred aspect of the invention, the fabric is reduced to a thickness of from about 0.030 inches to about 0.300 inches. In an even more preferred aspect of the invention, the fabric is from about 0.060 inches to about 0.180 inches thick.

The newly-exposed surface of a split sheet of non-woven fabric, for example, may possess a physical or chemical property that is different from its other finished surface, such as adhesiveness, that makes it more suitable for bonding to other sheets of material to produce a laminated composite stiffener material. In some cases, it may be easier or desirable to bond a sheet of material to the finished surface using a different adhesive, and apply and bond the laminated composite stiffener to a second sheet of material to its newly-exposed and adhesive surface. The physical and chemical properties of the core and laminated materials can be varied to produce laminated composite stiffener materials which vary in properties such as overall strength, density, porosity, or solvent and water repellency.

In a preferred aspect of the invention, the method further comprises the step of: (d) bonding one or more sheets of resilient material to at least one side of the non-woven sheet of fabric to form a laminated composite stiffener material. In a more preferred aspect of the invention, resilient material comprises a thermoplastic elastomer. In a most preferred aspect of the invention, the thermoplastic elastomer is selected from the group consisting of styrenics, copolyesters, polyurethanes, polyamides, thermoplastic polyolefins, thermoplastic vulanizates, polyolefin plastomers, polyolefin elastomers, and reactor-made thermoplastic polyolefin elastomers. A most preferred thermoplastic elastomer comprises an ethylene methacrylic acid copolymer, such as DuPont SURLYN® and related ionomers. In a preferred aspect of the invention, the laminated composite stiffener material is selected from the group consisting of: (i) one non-woven sheet of fabric bonded on one side to one sheet of resilient material; (ii) one non-woven sheet of fabric bonded on both sides to an upper and a lower sheet of resilient material; and (iii) one sheet of resilient material bonded on both sides to an upper and lower sheet of the non-woven sheet of fabric.

In a preferred aspect of the invention, the method further comprises the step of: (e) bonding an adhesive material on at least one side of the laminated composite stiffener material to form an adhesive laminated composite stiffener material. The adhesive material can be applied to or bonded on one side of the laminated composite stiffener material, or to both sides of the laminated composite stiffener material. In one aspect of the invention, the adhesive material is in the form of a sheet. In an another aspect of the invention, the adhesive material is discontinuously applied to the laminated stiffener material. While step (d) normally follows step (c), as noted above, the step (e) of bonding a sheet of material to at least one side of the non-woven sheet of fabric can occur after step (c), or after step (d).

The methods described above can further comprise the step of forming the non-woven sheet of fabric into an article. In a preferred aspect of the invention, the method further comprises the step of: (f) forming the adhesive laminated composite stiffener material into an article component. A wide variety of article components requiring stiffener materials are within the scope of the invention, including footwear components in which the non-woven sheet of fabric of sheet is formed into a footwear component shape and heated to permit molding and assembly of the shaped part into footwear.

Preferred articles of the method include footwear parts which are shaped and heated to permit molding and attachment of the shaped part into the footwear. Preferred footwear components include box toes, counters, and insoles. The articles may be shaped or cut by a variety of methods, such as stamping or deforming with a die, to produce a desired form augmented by physical or chemical treatments, such as heating, cooling, radiation, and/or electrical exposure, which facilitate production in a timely and cost-effective manner.

In a preferred aspect of the invention, at least one of the multi-component fibers is a bi-component fiber. In a more preferred aspect of the invention, the first component of the bi-component fiber is a polyester having a first melting point and the second component is a polyester having a second melting point. In a more preferred aspect of the invention, the first melting point is lower than the second melting point by at least 50° F. In a preferred aspect of the invention, the first melting point is from about 150° F. to about 250° F. and the second melting point is from about 200° F. to about 400° F., depending on the relative features of the physical properties, such as softening temperature, melting point, etc., of the different components

Another aspect of the invention includes a method of preparing a footwear part comprising a composite stiffener material in the form of a nonwoven sheet of fabric comprising a blend of single component fibers and bi-component fibers, the bi-component fiber having a first lower melting point for one component and a second higher melting point for a second component, comprising the steps of: (a) entangling the fibers to form a fabric; (b) heating the fabric being heated to a temperature sufficient to melt the first component of the bi-component fiber without permanent structural impairment of the second component; (c) reducing the thickness of the fabric to a pre-selected thickness; and (d) forming the sheet into a footwear component shape; and (e) heating to permit molding and attachment of the footwear component shape to another component of the footwear.

Another aspect of the invention includes a method of preparing a footwear component comprising a composite stiffener material in the form of a nonwoven sheet of fabric by the steps of: (a) providing a bi-component fiber having a first lower melting point component and a second high melting point component; (b) forming the fiber into a fabric; (c) heating the fabric sufficiently to melt the first component so as to bond the second component of the fabric; (d) passing the fabric through at least one set of rollers to reduce the material of the thickness of the fabric; (e) cooling the fabric; (f) reheating the fabric; (g) forming at least one footwear component from the fabric; (h) maintaining the temperature of the fabric at a level sufficient to cause the first component of the bi-component fiber to become sticky; and (i) attaching the footwear component comprising the composite stiffener material to another part of the footwear.

Another aspect of the invention includes a method of forming a box toe for a shoe comprising the steps of: (a) forming a fabric from a predetermined ratio of a bi-component fiber and a single-component fiber, the bi-component fiber having a first lower melting component and a second higher melting point component; (b) heating the fabric sufficiently to melt the first component of the bi-component fiber so as to bond the second component of the bi-component fiber with the single component fiber of the fabric; (c) passing the material through at least one set of rollers to obtain a pre-determined thickness of the material; (d) heating the material to enable forming a box toe for a shoe; (e) heating to material to re melt the first bi-component of the bi-component material; and (f) attaching the material to another shoe component by the interaction of the first bi-component and the another shoe component.

The present invention also relates to method of making a stiffener material comprising a multi-component fiber, each component fiber preferably having a different melting point, wherein the multi-component fiber is a bi-component fiber, comprising a first fiber having a relatively high melting point, which is coated with a second fiber component having a relatively lower melting point. Bi-component fibers are commonly prepared by extruding two polymers from the same spinneret with both polymers contained within the same filament. The first and the second fiber components may be composed of the same material or different materials. A preferred material is polyester. Other materials commonly used in the shoe manufacturing process requiring fibers having different melting points are also encompassed by the invention.

In the description provided below, the multi-component fiber is described as a bi-component fiber, comprising a first polyester fiber having a relatively high melting point, coated with a second polyester fiber having a relatively lower melting point. Shoe stiffener materials, for example, can be prepared from multi-component fibers made of polyester or similar polymers having the desired melting point characteristics. The method described here can be used to prepare composite stiffener materials used in shoe manufacturing at a lower cost than methods described in the prior art.

In a preferred aspect of the invention, a bi-component fiber is layered in a conventional way, and needle-punched to form a fabric. The fabric is heated to a temperature sufficient to melt the lower temperature component of the bi-component filter fiber and soften the second component of the bi-component fiber, causing the fabric to form a cohesive mass. The cohesive mass of fabric is nipped between calendared rollers, compacting the material into a dense non-woven mass having a desired thickness. When hardened, the resulting material has physical properties suitable for use as a shoe stiffener material in the production of box toes and counters, for example, at a substantially lower cost then saturated non-woven fabric materials having a similar.

One aspect of the invention is a stiffener material comprising a multi-component fiber, wherein the fibers are layered to form a non-woven fabric, such that the thickness of the fabric can be varied simply by altering the diameter of the bi-component fiber, keeping the weight of the non-woven material the same. A material that is 24 oz. by weight, for example, could be made from bi-component fibers that are passed through the rollers to compact the material down to a desired predetermined thickness, such as, 0.095 inches. A thinner material having the same weight could also be made from thicker bi-component fibers that are compressed to 0.15 thousandths of an inch. Those skilled in the art will recognize that stiffener materials can be made from a variety of other components to produce composite materials having different thicknesses, weights, or other desirable properties.

One aspect of the invention relates to a method of making thermoplastic structures without saturation of thermoplastic resins using binder fibers or bi-component fibers. The inner polyester (PET) core of a bi-component (bico) fiber, for example, will have a melting point such that it becomes soft between 170° F. and 220° F., which is sufficient to facilitate the molding of a box toe or a counter in a shoe factory. The outer layer (or sheath) polyester will melt at a temperature to allow the fibers to fuse together when the non-woven fabric is run through a heat tunnel during manufacture to activate the surface of sheath polyester to form a cohesive mass. The cohesive mass is then run through calander rollers to control the final thickness of the finished fabric.

Component and process parameters may be varied to produce products having desired properties. Fabric weight, fiber diameter or denier, and polymer melting points, for example, may all be used to vary the weight and thickness of a finished fabric. Other properties of the material, such as porosity, stiffness, or density, may be altered by using fiber components having different physical or chemical properties, such as color, tensile strength, and absorbency. The use of multi-component fibers having different melting points to prepare stiffener materials generally eliminates the need for adhesives or saturants, such as that used in the production of similar articles prepared from thermoplastic latexes.

One aspect of the invention is a low-cost composite stiffener material for box toes and shoe or boot counters based on multi-component fibers comprising a thermoplastic polymer. A preferred aspect of the invention is a bi-component or binder fiber comprising at least one thermoplastic component having a relatively lower melting point than other components of the multi-component or bi-component fiber.

In one aspect of the invention, the core component of a bi-component fiber forming the composite stiffener material is thermoplastic material having a low softening point such as polyester (requiring 160° F. to 180° F. to soften). The core softens under heat to allow molding of the softened structure around the heel and toe in shoe manufacturing. The sheath of the bi-component fiber is a plastic material having a low melt point such as polyester or is a hot melt adhesive which permits the fibers to bind together under heat and pressure when compressed to form a non-woven fabric during manufacturing. Products having varying degrees of water absorption or repellency, porosity, and density, for example, can be made by varying the ratio of multi-component fiber to single- or mono-component fiber, such as the percentage of multi-component fiber of all fibers in the composite stiffener material is >20%, >30%, >40%, >50%, >60%, >70%, >80%, >90%, >95%, or >99% depending on the desired physical properties, such as stiffness, thickness, or porosity of the finished product. When a higher percentage of multi-component fibers are used to prepare the composite stiffener materials, the final product will be more dense or compact, and perhaps film-like, compared to products prepared from a lower percentage of multi-component fibers, which produce more porous composite stiffener materials.

In one aspect of the invention, fibers forming the material are carded and cross-lapped or layered in a conventional manner and the layered mass that results is needle punched to form a non-woven material. The material is then heated to a temperature which melts the thermoplastic material which comprises the sheath component of the bi-component fiber but merely softens or does not affect component having the relatively higher melt point temperature. After heating, the material is calendared to make it more compact and dense, and the melted component facilitates the fusing of fibers to produce a material having structure more readily described as a cohesive mass.

Process parameters can be varied and different components can be used to alter the structural properties of the cohesive mass. The weight of bi-component fibers utilized for the fabric can remain relatively constant, for example, while the thickness of the bi-component fibers is varied to provide products that vary in thickness after compacting, but having similar weights per area of material. Alternatively, the thickness of the fibers can remain constant and the thickness after compacting varied to produce products having varied weights per area of material.

Finished material can be processed by a variety of methods, such as die cutting, to form objects that are formed into suitable shapes, such as box toes or counters used in the shoe manufacturing process. The composite stiffener material then is heated so that the core thermoplastic material of a multi-component fiber component softens and the material is shaped for its particular application in the shoe manufacturing process. The composite stiffener material has excellent adhesive properties when applied to conventional shoe upper and liner materials by itself under appropriate thermal conditions, or when it is coated with additional adhesive to facilitate the assembly process.

The composite stiffener material of the invention may be prepared from a blend of multi-component thermoplastic fibers, which may be altered to produce composite stiffeners having different physical or chemical properties. A preferred aspect of the invention uses high ratio of multi-component thermoplastic fibers to single- or mono-component thermoplastic, non-thermoplastic (thermoset), or natural fibers.

The invention relates to composite stiffener materials, laminated composite stiffener materials, and adhesive laminated composite stiffener materials, prepared by any of the methods described above. The invention relates to article components selected from the group consisting of footwear components, luggage components, and holster components comprising the composite stiffener material prepared by prepared by any of the methods described above. Preferred articles of the invention include footwear components such as footwear components include box toes, counters, and insoles comprising the composite stiffener material prepared by prepared by any of the methods described above.

The present invention relates to a composite stiffener material in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point. The composite stiffener materials can be prepared in a variety of other forms, such as multi-filament fibers twisted in a non-interlaced helical pattern, or braided in an interlaced fashion, optionally around a central core of fiber or other material, as in a rope, string, or cord.

In a preferred aspect of the invention, the fibers are entangled to form a fabric, the fabric is heated to a temperature sufficient to melt at least one thermoplastic material of a multi-component fiber without permanent structural impairment of other fiber components; and the heated fabric is reduced in thickness to form a non-woven sheet of fabric. In a most preferred aspect of the invention, the thermoplastic material in at least one component of the one or more multi-component fibers is a hot melt material or a polyester selected from the group consisting of polyglycolic acid (PGA), polylactic acid (PLA), polycaprolactone (PCL), polyethylene adipate (PEA), polyhydroxyalkanoate (PHA), polyethylene terephthalate (PET), polybutylene terephthalate (PBT), polytrimethylene terephthalate (PTT) polyethylene naphthalate (PEN) and vectran. In a most preferred aspect of the invention, the polyester is polyethylene terephthalate (PET). In a preferred aspect of the invention, the composite stiffener material comprises a blend of one or more multi-component fibers and one or more single-component fibers.

In a preferred aspect of the invention the composite stiffener material has a thickness of from about 0.030 inches to about 0.300 inches.

In a preferred aspect of the invention one or more sheets of resilient material are bonded to at least one side of the non-woven sheet of fabric to form a laminated composite stiffener material. In a more preferred aspect of the invention, the resilient material comprises a thermoplastic elastomer. In a most preferred aspect of the invention, thermoplastic elastomer is selected from the group consisting of styrenics, copolyesters, polyurethanes, polyamides, thermoplastic polyolefins, thermoplastic vulanizates, polyolefin plastomers, polyolefin elastomers, and reactor-made thermoplastic polyolefin elastomers. In a most preferred aspect of the invention, thermoplastic elastomer comprises an ethylene methacrylic acid copolymer. In a preferred aspect of the invention, the laminated composite stiffener material is selected from the group consisting of: (i) one non-woven sheet of fabric bonded on one side to one sheet of resilient material; (ii) one non-woven sheet of fabric bonded on both sides to an upper and a lower sheet of resilient material; and (iii) one sheet of resilient material bonded on both sides to an upper and lower sheet of the non-woven sheet of fabric.

In a preferred aspect of the invention, an adhesive material is applied to or bonded on at least one side of the laminated composite stiffener material to form an adhesive laminated composite stiffener material. In a preferred aspect of the invention, the adhesive material is bonded on one side of the laminated composite stiffener material. In a preferred aspect of the invention, the adhesive material is bonded on both sides of the laminated composite stiffener material. In a preferred aspect of the invention, the adhesive material is in the form of a sheet. In a preferred aspect of the invention, the adhesive material is discontinuously applied to the laminated stiffener material. Exemplary methods of discontinuous methods include applications of adhesive in linear stripes or dots separated by spaces lacking adhesive, in uniform or random patterns such that the final product has sufficient adhesive, when needed, to bond to other materials used in the preparation and assembly of articles or article parts.

In a preferred aspect of the invention, at least one of the multi-component fibers is a bi-component fiber. In a preferred aspect of the invention, the first component of the bi-component fiber is a polyester having a first melting point and the second component is a polyester having a second melting point. In a preferred aspect of the invention, the first melting point is lower than the second melting point by at least 50° F. In a preferred aspect of the invention, the first melting point is from about 150° F. to about 250° F. In a preferred aspect of the invention, the second melting point is from about 200° F. to about 400° F.

The present invention relates to articles and article components comprising composite stiffener material, laminated composite stiffener material, and adhesive laminated composite stiffener materials described above, without regard to their method of preparation. Article components can include, for example, footwear components, luggage components, and holster components comprising the composite stiffener material. Preferred articles of the invention include footwear components such as box toes, counters, and insoles comprising the composite stiffener materials of the invention.

A preferred aspect of the invention relates to a composite stiffener material wherein at least one component of the one or more multi-component fibers is a colored component. A more preferred aspect of the invention relates to a composite stiffener material comprising a blend of one or more multi-component fibers and one or more single-component fibers. A more preferred aspect of the invention includes a composite stiffener material wherein at least one of the blend of one or more multi-component fibers and one or more single-component fibers is a colored fiber. Other preferred aspects of the invention include composite stiffener materials wherein at least one component of the one or more multi-component fibers is a natural fiber. Another preferred aspect of the invention includes composite stiffener materials wherein at least one component of the one or more single-component fibers is a natural fiber.

The invention also relates to articles comprising a composite stiffener material of the invention, including articles comprising the composite stiffener material made by the methods of the invention described above. In a preferred aspect of the invention, these articles include footwear, luggage, holsters, and related accessories. A variety of other consumer and business goods may also comprise the composite stiffeners of the invention, where they provide a means of support, and in some cases, protecting objects from damage during ordinary use or shipping. The means of support or protection may be integral to the object, such as footwear, but need not be visible when the object is ordinarily viewed by the consumer or end-user. In other cases, the article provides support or protection, that is visible on the exterior of an object, and its use may be temporary or permanent. Preferred articles include footwear, such as shoes and boots, and footwear components used in their production. Preferred footwear components which comprise composite stiffener materials of the invention, include box toes, counters, and insoles.

### Example 1

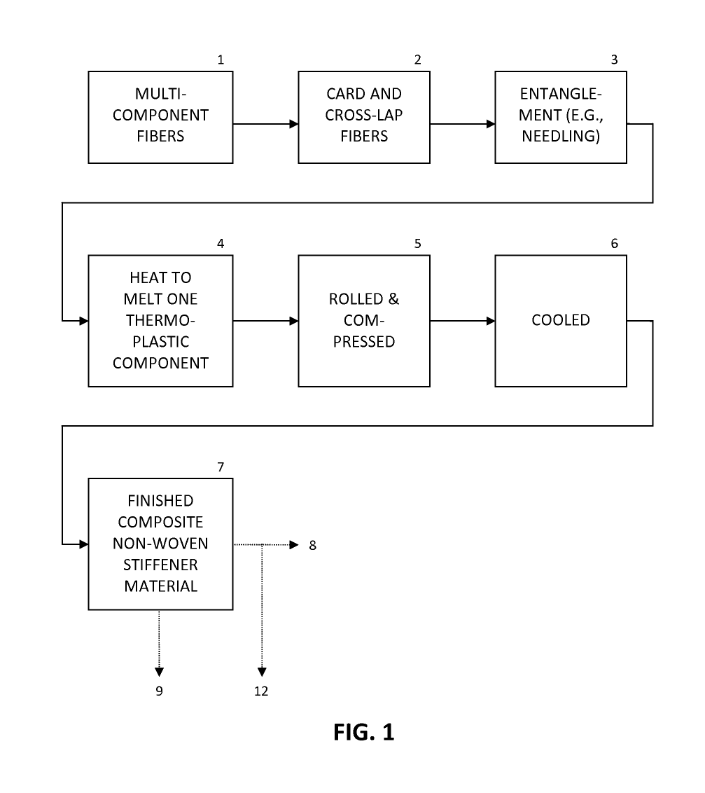

FIG. 1, sets forth one method of producing the composite stiffener material of the present invention shown in diagrammatic form. Suitable polymer materials are extruded in the form of one or more multi-component fibers (exemplified herein as bi-component fibers) and/or one or more single-component fibers in predetermined ratios as shown in reference 1. The fibers are introduced to a carding machine 2 to create a batt of material. The batt of material is then transferred in a conventional way to an entanglement station 3, which entangles the fibers to create a non-woven material. A variety of methods can be used to entangle fibers. These include high pressure water systems (to produce what are referred to as spun-laced non-woven fabrics), air lay methods, or in a preferred aspect of the invention, by needle punching the batt with an oscillating needle to mechanically entangle the fibers. Other methods of fiber entanglement may be used.

The non-woven material is then passed through a heat chamber 4, maintained at a predetermined temperature sufficient to melt the outer coating of the bi-component fiber and generally not affecting the structural integrity of the other polymer of the bi-component fiber. The heat chamber is preferably is a gas- or electrically-operated chamber furnace. The operating temperature of the heat chamber will depend upon the melting points of the thermoplastic components of the multi-component fibers, such as 300° F. to 400° F., when the thermoplastic components are polyester or related polymers. After heating, the material is passed through one or more rollers 5 to reduce its thickness to a predetermined amount.

Stiffening materials commonly have a thickness between 0.030 and 0.160 inches, which are achieved by compressing various thicknesses of non-woven base weight material to produce products having a weight between 12 oz. and 35 oz. per square yard. The properties of finished composite material can be altered by varying the thickness and/or ounce weight per square yard of the multi-component fibers. A thicker composite product can be produced, for example, if a thicker fiber is used, even if the rolling process is similar to that used for a fiber having a thinner diameter.

After rolling, the material is allowed to cool at station 6 and the finished material 7 which is optionally split 8 and formed into sheets or rolls, which may be optionally bonded to a resilient material 9 to form a laminated composite stiffener material 10. An adhesive 11 may optionally be applied to the composite stiffener material or the laminated composite stiffener material. When used for insoles, the resilient material 9 provides an advantage over prior art constructions in that the insole remains flexible, and requires no adhesive saturation step in the construction process, and prevents liquid migration through the insole in applicational use. The composite stiffener material is then formed into suitable article parts 12, such as box toes or counters, and the article parts applied to or assembled into articles such as shoes at 13. When used for box toes and counters, the material is heated again so that it may be shaped for application in a shoe. Preferably, the low temperature component of the bi-component fiber becomes tacky or sticky to the touch, which facilitates the attachment of the box toe or counter to the upper and associated liners. Supplemental adhesive or hot melt coating may also be used to facilitate attachment of various shoe components, if desired. It is important to note that in one aspect of the invention, non saturated non woven material is attached to the resilient material 9. The composite material 10 then can be processed to provide a variety of materials. Because the non woven is not saturated, the resulting product is easier to process and has a reduced manufacturing cost.

While the preferred embodiments of the invention have been illustrated and described in detail, it will be appreciated by those skilled in the art that that various changes can be made therein without departing from the spirit and scope of the invention. Accordingly, the particular arrangements disclosed are meant to be illustrative only and not limiting as to the scope of the invention, which is to be given the full breadth of the appended claims and any equivalent thereof. All references, patents, or applications cited herein are incorporated by reference in their entirety, as if written herein.

What is claimed is:

1. A method of preparing a composite stiffener material in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point, comprising the steps of:
(a) entangling the fibers to form a fabric;
(b) heating the fabric to a temperature sufficient to melt at least one thermoplastic material of a multi-component fiber without permanent structural impairment of other fiber components; and
(c) reducing the thickness of the heated fabric to form a non-woven sheet of fabric.

2. The method of claim 1, wherein the thermoplastic material in at least one component of the one or more multi-component fibers, is a hot melt material or a polyester selected from the group consisting of polyglycolic acid (PGA), polylactic acid (PLA), polycaprolactone (PCL), polyethylene adipate (PEA), polyhydroxyalkanoate (PHA), polyethylene terephthalate (PET), polybutylene terephthalate (PBT), polytrimethylene terephthalate (PTT) polyethylene naphthalate (PEN) and vectran.

3. The method of claim 2, wherein the polyester is polyethylene terephthalate (PET).

4. The method of claim 1, comprising a blend of one or more multi-component fibers and one or more single-component fibers.

5. The method of claim 1, wherein the fibers are entangled by needle punching.

6. The method of claim 1 wherein the non-woven sheet of fabric is split into two or more thinner non-woven sheets of fabric.

7. The method of claim 1, wherein the thickness is reduced by passing the fabric through at least one set of rollers.

8. The method of claim 7, wherein the fabric is reduced to a thickness of from about 0.030 inches to about 0.300 inches.

9. The method of claim 8, wherein the fabric is from about 0.060 inches to about 0.180 inches thick.

10. The method of claim 1, further comprising the step of:
(d) bonding one or more sheets of resilient material to at least one side of the non-woven sheet of fabric to form a laminated composite stiffener material.

11. The method of claim 10, wherein the resilient material comprises a thermoplastic elastomer.

12. The method of claim 11, wherein the thermoplastic elastomer is selected from the group consisting of styrenics, copolyesters, polyurethanes, polyamides, thermoplastic polyolefins, thermoplastic vulanizates, polyolefin plastomers, polyolefin elastomers, and reactor-made thermoplastic polyolefin elastomers.

13. The method of claim 11, wherein the thermoplastic elastomer comprises an ethylene methacrylic acid copolymer.

14. The method of claim 10, wherein the laminated composite stiffener material is selected from the group consisting of:
(i) one non-woven sheet of fabric bonded on one side to one sheet of resilient material;
(ii) one non-woven sheet of fabric bonded on both sides to an upper and a lower sheet of resilient material; and
(iii) one sheet of resilient material bonded on both sides to an upper and lower sheet of the non-woven sheet of fabric.

15. The method of claim 10, further comprising the step of:
(e) applying or bonding an adhesive material on at least one side of the laminated composite stiffener material to form an adhesive laminated composite stiffener material.

16. The method of claim 15, further comprising the step of:
(f) forming the adhesive laminated composite stiffener material into an article component.

17. The method of claim 16, wherein the article component is a footwear component in which the non-woven sheet of fabric of sheet is formed into a footwear component shape and heated to permit molding and assembly of the shaped part into footwear.

18. The method of claim 17, wherein the footwear component is selected from the group consisting of box toes, counters, and insoles.

19. The method of claim 1, wherein at least one of the multi-component fibers is a bi-component fiber.

20. The method of claim 19, wherein the first component of the bi-component fiber is a polyester having a first melting point and the second component is a polyester having a second melting point.

21. The method of claim 20, wherein the first melting point is lower than the second melting point by at least 50° F.

22. The method of claim 21, wherein the first melting point is from about 150° F. to about 250° F.

23. The method of claim 21, wherein the second melting point is from about 200° F. to about 400° F.

24. A method of preparing a footwear part comprising a composite stiffener material in the form of a nonwoven sheet of fabric comprising a blend of single component fibers and bi-component fibers, the bi-component fiber having a first lower melting point for one component and a second higher melting point for a second component, comprising the steps of:
(a) entangling the fibers to form a fabric;
(b) heating the fabric being heated to a temperature sufficient to melt the first component of the bi-component fiber without permanent structural impairment of the second component;
(c) reducing the thickness of the fabric to a pre-selected thickness; and
(d) forming the sheet into a footwear component shape; and
(e) heating to permit molding and attachment of the footwear component shape to another component of the footwear.

25. A method of preparing a footwear component comprising a composite stiffener material in the form of a nonwoven sheet of fabric by the steps of:
(a) providing a bi-component fiber having a first lower melting point component and a second high melting point component;
(b) forming the fiber into a fabric;
(c) heating the fabric sufficiently to melt the first component so as to bond the second component of the fabric;
(d) passing the fabric through at least one set of rollers to reduce the material of the thickness of the fabric;
(e) cooling the fabric;
(f) reheating the fabric;
(g) forming at least one footwear component from the fabric;
(h) maintaining the temperature of the fabric at a level sufficient to cause the first component of the bi-component fiber to become sticky; and
(i) attaching the footwear component comprising the composite stiffener material to another part of the footwear.

26. A method of forming a box toe for a shoe comprising the steps of:
(a) forming a fabric from a predetermined ratio of a bi-component fiber and a single-component fiber, the bi-component fiber having a first lower melting component and a second higher melting point component;
(b) heating the fabric sufficiently to melt the first component of the bi-component fiber so as to bond the second component of the bi-component fiber with the single component fiber of the fabric;
(c) passing the material through at least one set of rollers to obtain a pre-determined thickness of the material;
(d) heating the material to enable forming a box toe for a shoe;
(e) heating to material to re melt the first bi-component of the bi-component material; and
(f) attaching the material to another shoe component by the interaction of the first bi-component and the another shoe component.

27. The composite stiffener material prepared by the method of claim 1.

28. The laminated composite stiffener material of prepared by the method of claim 2.

29. The adhesive laminated composite stiffener field of prepared by the method of claim 3.

30. A footwear component comprising the composite stiffener prepared by the method of claim 1.

31. A composite stiffener material in the form of a nonwoven sheet of fabric comprising one or more multi-component fibers, wherein at least one component of the one or more multi-component fibers is a thermoplastic material, and each thermoplastic material within a multi-component fiber having two or more thermoplastic materials has a different melting point.

32. The composite stiffener material of claim 31 wherein the fibers are entangled to form a fabric, the fabric is heated to a temperature sufficient to melt at least one thermoplastic material of a multi-component fiber without permanent structural impairment of other fiber components; and the heated fabric is reduced in thickness to form a non-woven sheet of fabric.

33. The composite stiffener material of claim 32, wherein the thermoplastic material in at least one component of the one or more multi-component fibers, is a hot melt material or a polyester selected from the group consisting of polyglycolic acid (PGA), polylactic acid (PLA), polycaprolactone (PCL), polyethylene adipate (PEA), polyhydroxyalkanoate (PHA), polyethylene terephthalate (PET), polybutylene terephthalate (PBT), polytrimethylene terephthalate (PTT) polyethylene naphthalate (PEN) and vectran.

34. The composite stiffener material of claim 33, wherein the polyester is polyethylene terephthalate (PET).

35. The composite stiffener material of claim 32, comprising a blend of one or more multi-component fibers and one or more single-component fibers.

36. The composite stiffener material of claim 32, wherein the fabric has a thickness of from about 0.030 inches to about 0.300 inches.

37. The composite stiffener material of claim 32 wherein one or more sheets of resilient material are bonded to at least one side of the non-woven sheet of fabric to form a laminated composite stiffener material.

38. The composite stiffener material of claim 37, wherein the resilient material comprises a thermoplastic elastomer.

39. The composite stiffener material of claim 38, wherein the thermoplastic elastomer is selected from the group consisting of styrenics, copolyesters, polyurethanes, polyamides, thermoplastic polyolefins, thermoplastic vulanizates, polyolefin plastomers, polyolefin elastomers, and reactor-made thermoplastic polyolefin elastomers.

40. The composite stiffener material of claim 38, wherein the thermoplastic elastomer comprises an ethylene methacrylic acid copolymer.

41. The composite stiffener material of claim 37, wherein the laminated composite stiffener material is selected from the group consisting of:
(i) one non-woven sheet of fabric bonded on one side to one sheet of resilient material;
(ii) one non-woven sheet of fabric bonded on both sides to an upper and a lower sheet of resilient material; and
(iii) one sheet of resilient material bonded on both sides to an upper and lower sheet of the non-woven sheet of fabric.

42. The composite stiffener material of claim 37, further wherein an adhesive material is applied to or bonded on at least one side of the laminated composite stiffener material to form an adhesive laminated composite stiffener material.

43. The composite stiffener material of claim 31, wherein at least one of the multi-component fibers is a bi-component fiber.

44. The composite stiffener material of claim 43, wherein the first component of the bi-component fiber is a polyester having a first melting point and the second component is a polyester having a second melting point.

45. The composite stiffener material of claim 44, wherein the first melting point is lower than the second melting point by at least 50° F.

46. The composite stiffener material of claim 45, wherein the first melting point is from about 150° F. to about 250° F.

47. The composite stiffener material of claim 45, wherein the second melting point is from about 200° F. to about 400° F.

48. A footwear component comprising the composite stiffener material of claim 31.
